(19) United States
(12) Patent Application Publication
(10) Pub. No.: US 2016/0281414 A1
(43) Pub. Date: Sep. 29, 2016

(54) WINDOW ASSEMBLY TO ENGAGE A WINDOW TO THE FRAME OF A WINDOW OPENING OF A BUILDING

(71) Applicant: OLMOS SCOFIELD, LLC, San Antonio, TX (US)

(72) Inventor: TREVOR MARKHAM, San Antonio, TX (US)

(21) Appl. No.: 15/162,036

(22) Filed: May 23, 2016

Related U.S. Application Data
(63) Continuation-in-part of application No. 14/623,935, filed on Feb. 17, 2015.
Application No. 14/623,935 is a continuation of application No. 13/838,269, filed on Mar. 15, 2013, now Pat. No. 8,955,270.
(60) Provisional application No. 62/164,867, filed on May 21, 2015.
(60) Provisional application No. 61/647,796, filed on May 16, 2012.

(51) Int. Cl. E06B 1/36; E06B 3/26; E06B 3/54

(52) U.S. Cl. CPC E06B 1/36; E06B 3/5454; E06B 3/26

(57) ABSTRACT

A window for engagement with a building structure having a window opening, the window is providing a perimeter frame adapted to engage the window opening of the structure. The window has at least one window pane having a window pane perimeter. Structure is provided to allow outer siding to be attached around the window opening before the window is placed in the opening. The window uses multiple perimeter retainer members including an outer perimeter retainer member and an inner perimeter retainer member, the perimeter retainer members typically having opposed substantially flat walls configured to engage the outer pane surface and the inner pane surface, respectively, and perimeter clip member engaging walls.

This application claims priority to and the benefit of U.S. Provisional Patent Application No. 62/164,867, filed May 21, 2015, and incorporates the same by reference, and is a continuation in part of and incorporates by reference co-pending published U.S. patent application Ser. No. 14/623,935, which is a continuation of U.S. patent application Ser. No. 13/838,269 filed Mar. 15, 2013, which claims the benefit of U.S. Provisional Patent Application No. 61/647,796 filed May 16, 2012.

### FIELD OF THE INVENTION

Windows, more specifically, a fixed or casement (hinged) window having a perimeter assembly that allows easy engagement of the vertically sliding window to the frame of the house or other building structure.

### BACKGROUND OF THE INVENTION

U.S. Pat. No. 8,955,270, entitled Window Assemblies Including Bronze Elements, is incorporated herein by reference. This discloses, in one embodiment, a window for engagement with the building structure including a window opening, and a perimeter frame to engage the window opening to the window. This invention has proved successful in meeting its stated objectives.

### SUMMARY OF THE INVENTION

A window assembly for engaging a building structure, the building structure having walls defining a window opening and exterior siding, the window assembly comprising: a left and right receiver frame adapted with a first member to engage the walls of the window opening; and a window for removably engaging the receiver frame, the window comprising a left and right connector channel, and left and right perimeter frame assembly, wherein the perimeter frame assemblies include a left and right perimeter frame and at least one window panel; wherein the left and right receiver frame includes a second member, the second member for receiving a fastener and thereby engaging the connector channel of the window.

### BRIEF DESCRIPTION OF THE DRAWINGS

FIGS. 1, 1A, 1B, and 2 illustrate the fixed window embodiment of applicants window assembly.

FIGS. 3, 3A and 4 illustrate a hinged window embodiment of applicants window assembly, which may be a casement, hopper or awning window.

### DETAILED DESCRIPTION OF THE PREFERRED EMBODIMENT

A window assembly 200 is disclosed comprising a receiver frame 202 (on each of two, three or four sides of the window assembly) removeably engaging a window 204. A connector channel 206 (one on each of the at least two sides of the window assembly)and a perimeter frame assembly 208 comprise window 204. Fasteners 205a threadably engage connector channel 206 to receiver frame 202. The entire window assembly 200 is dimensioned to engage a building 300 having rectangular walls 302 defining a rectangular window opening.

In a preferred embodiment, window assembly 200 is engaged to inward facing wall surfaces 302a of rectangular walls 302 through the use of fasteners 301 attaching receiver frame 202 to building 300 in a manner that allows secure engagement of the window assembly to the building and also for the mounting of an exterior and/or interior siding 304, such as stucco or siding to the building while being flush to the window and hiding most of the receiver frame from view. In a preferred method for installation of the window assembly, the window assembly 200 is secured with fasteners 301 through the receiver frame 202 into rectangular walls 302, where, before fasteners 301 are attached, window assembly 200 is plumbed, leveled and centered in the window opening, through the use of shims or other suitable parts.

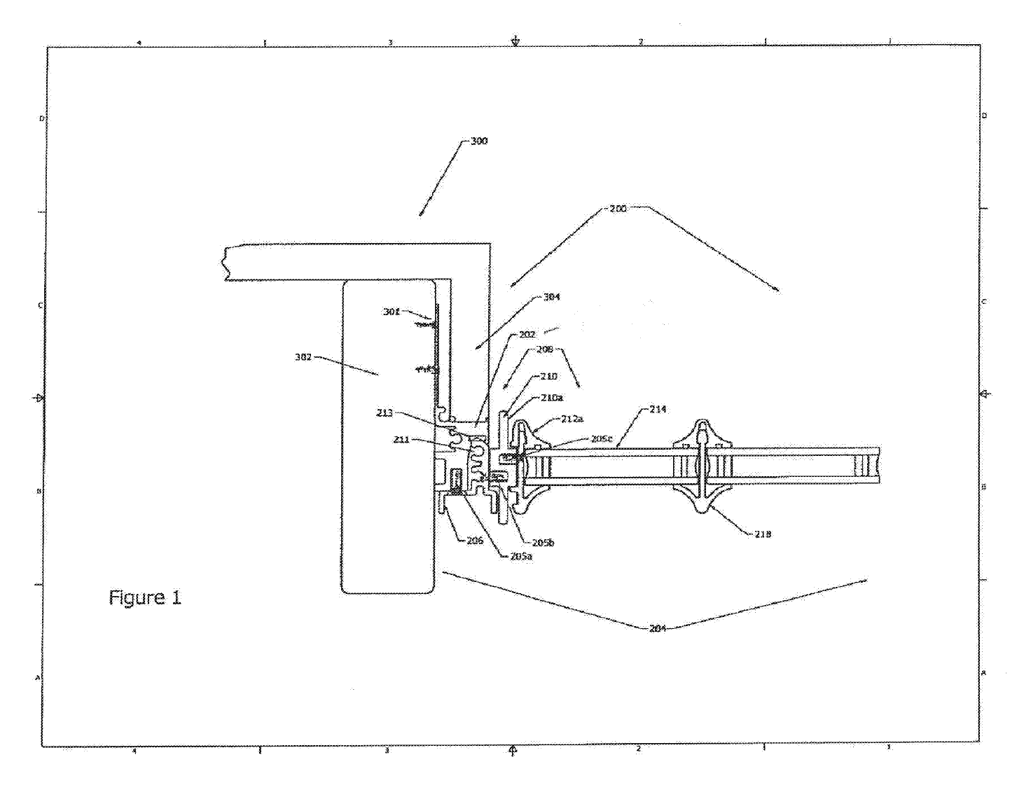

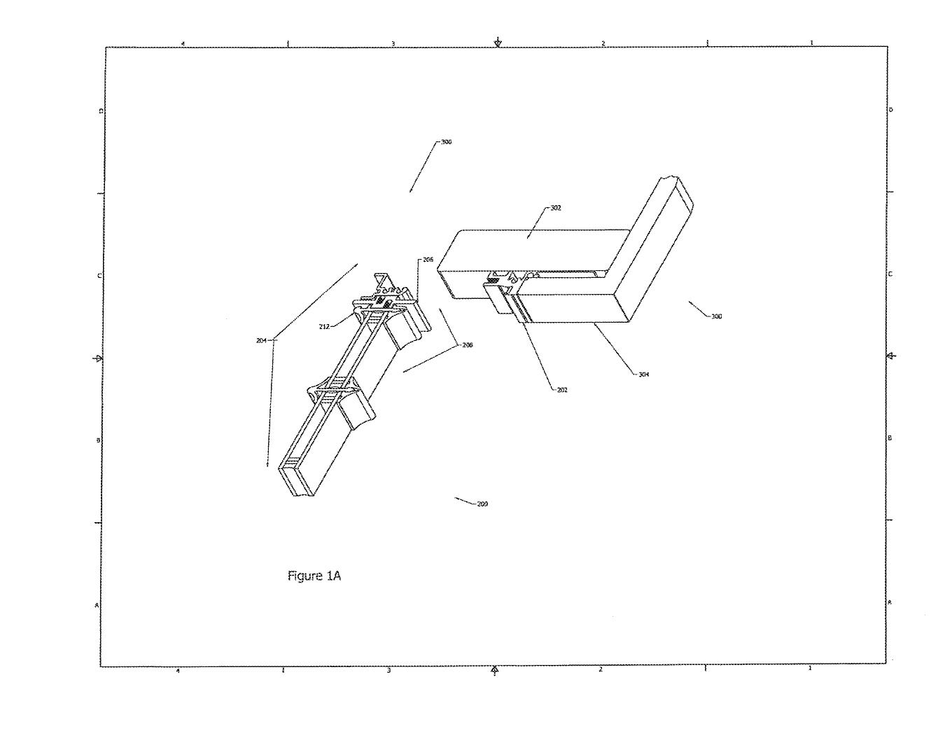

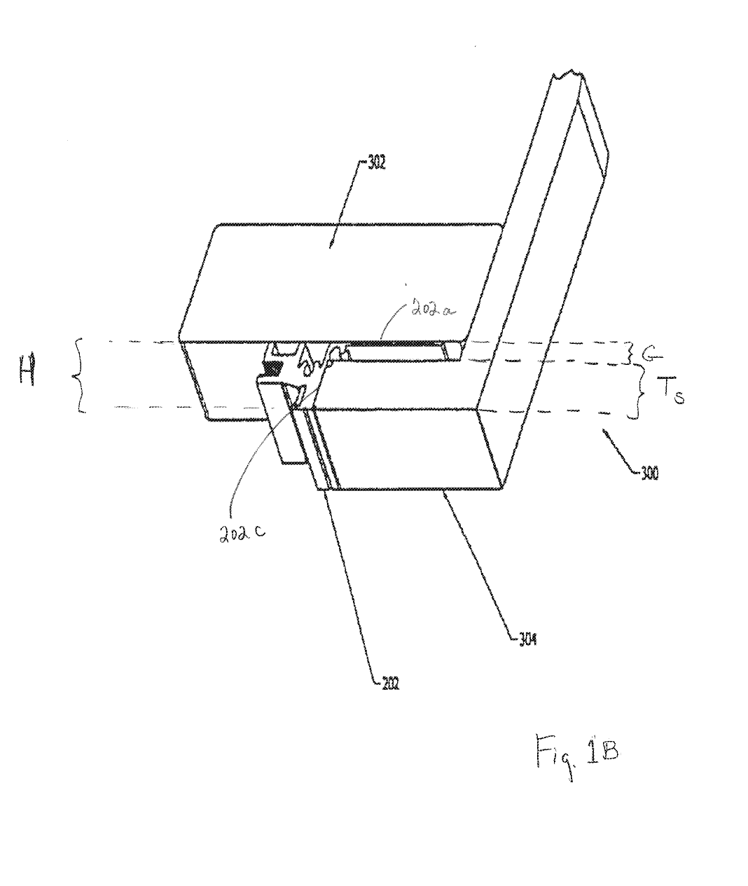

It is seen from FIG. 1 that window 204 can be added to or removed from receiver frame 202, for example, after fasteners 301 engage the receiver frame 202 to the building and before exterior siding 304 and other facia or completion members are applied to the building. As such, window 204, is out of the way, as it has been removed from receiver frame 202 by unthreading of fasteners 205a. This makes it easier for mounting exterior siding 304 to the building.

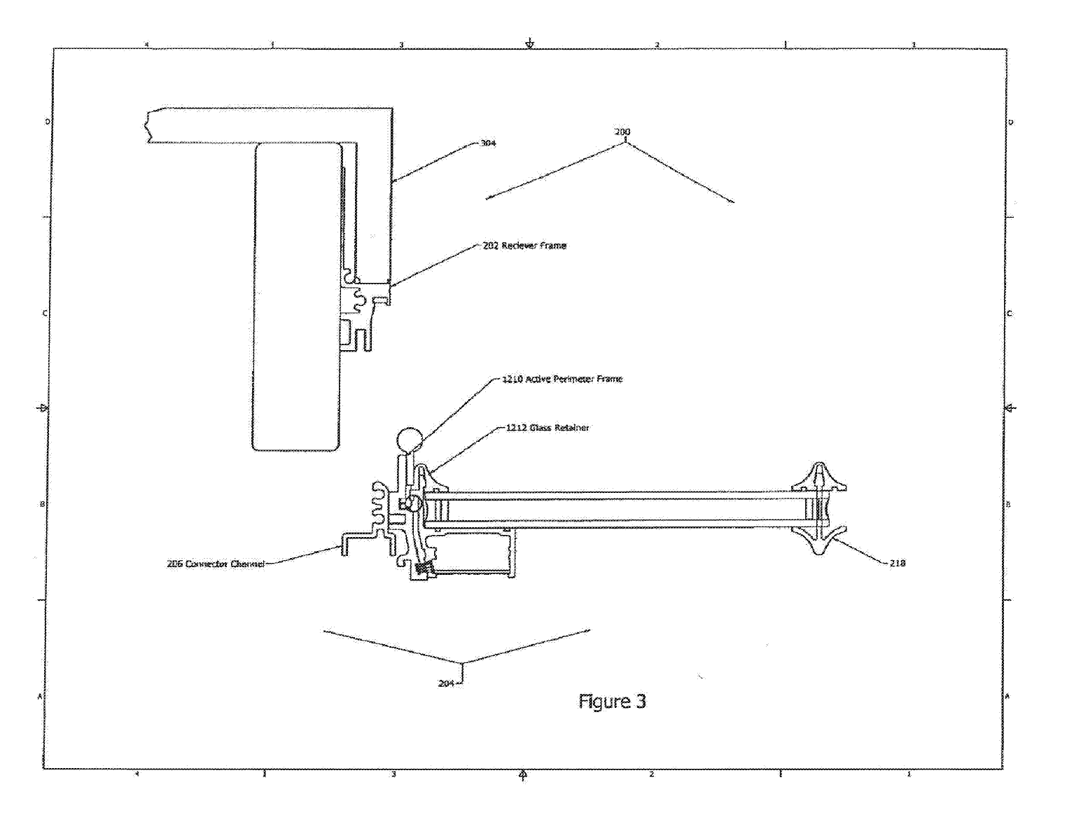

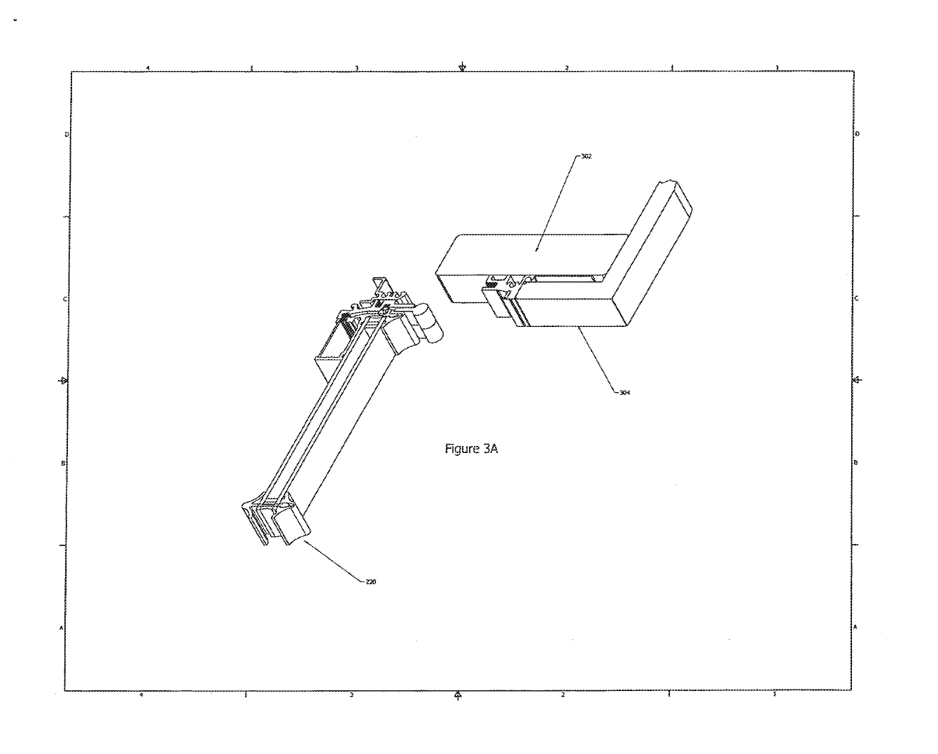

Window 204 includes connector channel 206 and perimeter frame assembly 208. Perimeter frame assembly 208 may include a perimeter frame 210, a fixed glass retainer 212, and a pane assembly 214. Pane assembly 214 may include windows alone 216 or windows with vertical dividers 218 and horizontal dividers 220 (see FIG. 3A). Fasteners 205a as set forth above removably fastened window 204 to receiver frame 202. Fasteners 205b removably engage perimeter frame 210 to connector channel 206. Fasteners 205c engage fixed glass retainer 212 to perimeter frame 210. Glass retainer 212 retains one more pane assemblies 214 to perimeter frame 210. In multi-pane embodiments vertical dividers 218 and horizontal dividers 220 are also provided. Elastomeric members 211 and 213 provide a seal between connector channel 206 and receiver frame 202 when window 204 removably engages receiver frame 202.

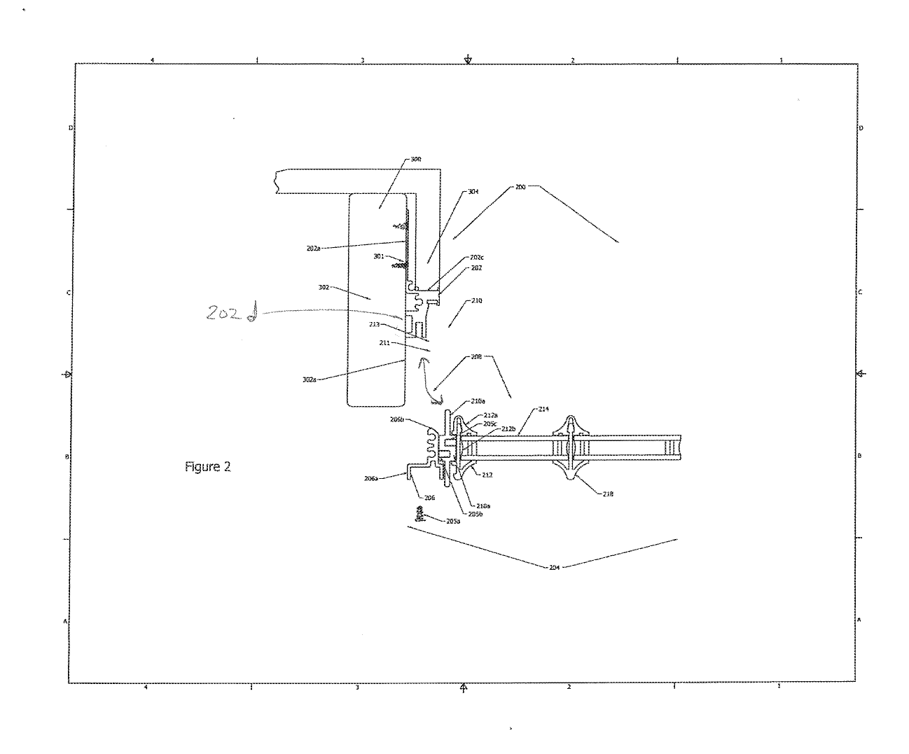

FIGS. 1, 1A and 2 illustrate further details of elements 202, 206, 210 and 212. Receiver frame 202 is seen to include first, second, third, and fourth members or portions and for the 202a/202b/202c/202d. First member 202a and fourth members 202d are configured to lay adjacent inward facing walls 302a and to receive fasteners 301 therethrough to engage the receiver frame to the building. Second member 202b is seen to be configured to receive fastener 205a and to engage connector channel 206. Third member 202c is seen to be configured to abut against and receive exterior 304, such as stucco thereupon. Therefore, it is seen that receiver frame 202 functionally achieves structural attachment to the building, engagement with a siding of the building in an aesthetically pleasing manner, and removable engagement with window 204 through connector channel 206. Moreover, exterior siding 304 may be placed on the building before window 204 is placed on with the building and the receiver frame is covered from view. In FIG. 10, it is seen that third member has a removed end that defines a height H of third member 202c that is at least about equal to or slightly greater than Gap “G” plus siding thickness Tₛ

Connector channel 206 of window 204 is seen to include first member 206a and second member 206b. First member 206a is seen to receive fastener 205a therethrough to abut against second member 202b of the receiver frame. First member 206a is also seen to be cup shaped for attachment with interior finish material, such as wall board. Perimeter frame 210 is seen to include a base 210a and a pair of arms 210b extending outward therefrom. One of the functions of perimeter frame 210 is to receive fasteners 205b (to connect with connector channel 206) and 205c (to connect with glass retainer). Arms 210b extend outward from the base and function to provide strength to perimeter frame assembly 208. Glass retainer 212 may include base 212b with removable glass retainer 212a extending thereto. The configuration of the retainer and base is to snugly and fixedly engage glass panes 216 as seen in FIG. 2. Moreover, base 212b may have holes therein to receive fasteners 205c to engage glass retainer 212 to perimeter frame 210.

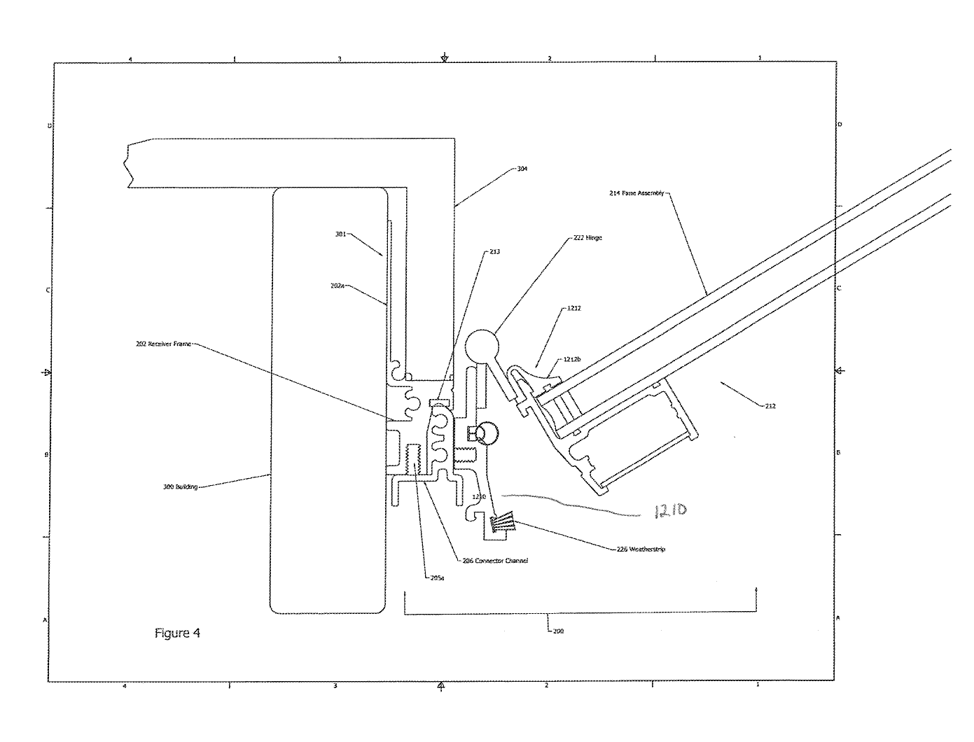

FIGS. 3, 3A and 4 illustrate the second embodiment of window assembly 200. In the first embodiment, window 204 was fixed and immovable. This alternate embodiment may be a casement, hopper or awning window. Pane assembly 214 is pivoted or hinged, in one embodiment, with the hinges 222 at the vertical side members of perimeter frame 1210, so as to open outwardly (see FIG. 4). In this alternate embodiment, functionally and structurally receiver frame 202 and connector channel 206 are substantially the same as set forth earlier. Likewise, the method of attachment using multiple fasteners. However, perimeter frame 1210 and glass retainer 1212 are not fixedly fastened to each other as in the earlier embodiment, but instead utilize a hinge 222, so as to pivotally engage perimeter frame 1210 to glass retainer 1212. In this manner, pane assembly 214 will pivot with respect to perimeter frame 1210. Weather strip 224/226 may be used between glass retainer 1212 and perimeter frame 1210 as seen in FIG. 4. Thus, the window can be removed and put back in easily and without removing the permanent mount to the building. Perimeter frame 210/1210 and any other visible elements may be formed from bronze.

Although the invention has been described with reference to specific embodiments, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A window assembly for engaging a building structure, the building structure having walls defining a window opening and exterior siding, such as stucco or brick, the window assembly comprising:
a left and right receiver frame each with a first and a fourth member to engage the walls of the window opening and a second member and third member; and
a window for removably engaging the receiver frame, the window comprising a left and right connector channel, and left and right perimeter frame assembly, wherein the perimeter frame assemblies include a left and right perimeter frame and a left and right window panel;
wherein the left and right receiver frame each engage the connector channel of the window, the second member of the receiver frame for receiving a fastener coupling the connector channel to the receiver frame, the third member of the receiver frame for receiving the exterior siding such that the exterior siding substantially covers the receiver frame from a viewer on the outside of the house.

2. The window assembly of claim 1, further including top and bottom receiver frames.

3. The window assembly of claim 1, wherein the left and right connector channels removably engage the left and right perimeter frame.

4. The window assembly of claim 3, wherein the left and right perimeter frame assemblies include a glass retainer for engaging the window panels.

5. The window assembly of claim 4, wherein the glass retainer includes a base and a removable member.

6. The window assembly of claim 1, wherein the perimeter frame assemblies include a hinge allowing one of the left or right window panels to pivot with respect to the plane of the window.

7. The window assembly of claim 6, wherein the hinge pivotally connects the perimeter frame to a glass retainer.

8. The window assembly of claim 1, wherein the exterior siding has an outer wall spaced apart from the walls of the building structure a distance “D”; and
wherein the receiver frame is dimensional to space the left and right perimeter frame a distance at least D from the walls of the building structure.

9. The window assembly of claim 8, further including top and bottom receiver frames.

10. The window assembly of claim 8, wherein the left and right connector channels removably engage the left and right perimeter frame.

11. The window assembly of claim 10, wherein the left and right perimeter frame assemblies include a glass retainer for engaging the window panels.

12. The window assembly of claim 11, wherein the glass retainer includes a base and a removable member.

13. The window assembly of claim 8, wherein the perimeter frame assemblies include a hinge allowing one of the left or right window panels to pivot with respect to the plane of the window.

14. The window assembly of claim 8, wherein the hinge pivotally connects the perimeter frame to a glass retainer.
